(19) United States
(12) Patent Application Publication
(10) Pub. No.: US 2016/0138566 A1
(43) Pub. Date: May 19, 2016

(54) SYSTEM AND PROCESS FOR STARTING THE FLIGHT OF POWER WING AIRFOILS, IN PARTICULAR FOR WIND GENERATOR

(71) Applicant: KITE GEN RESEARCH S.R.L., San Mauro Torinese (IT)

(72) Inventor: Massimo IPPOLITO, San Mauro Tourinese (IT)

(21) Appl. No.: 14/897,586

(22) PCT Filed: Jun. 5, 2014
(86) PCT No.: PCT/IT2014/000154

§ 371 Date: Dec. 10, 2015

(30) Foreign Application Priority Data
Jun. 12, 2013 (IT) TO2013A000480

(51) Int. Cl. F03D 7/06; F03D 5/00

(52) U.S. Cl. CPC F03D 7/06; F03D 5/00

(57) ABSTRACT

A system is described, for starting the flight of power wing airfoils, in particular for a wind generator, comprising at least one wing profile, operatively connected through control tie-rods, to winches or other control mechanisms of a flight of such wing profile, and at least one autonomous transporting flying vector adapted to be connected through disengageable connecting means to at least one wing profile and to transport in flight such wing profile. A process is further described, for starting the flight of such power wing airfoils through such system.

The present invention refers to a system and to a process for starting the flight of power wing airfoils, in particular for wind generator.

Different application fields are known in which it can be necessary to start the flight of a power wing profile, such as for example a kite-surf under conditions in which there is no wind on the ground. One of such application fields is the one dealing with electric energy wind generators, which exploit the flight of such wing profiles, like those, for example, disclosed in WO2008004261, WO2007122650, EP1672214, WO2008120257: in fact, though at certain heights there is always available an amount of wind enough to support the flight such profiles, it can happen that, on the contrary, on the ground there are situations in which wind is not enough to allow the autonomous takeoff or the start of flight of the wing profiles without external help.

Therefore, object of the present invention is solving the above prior art problems by providing a system and a process, in particular for wind generator, which allow starting the flight of power wing airfoils also without enough wind on the ground, through at least one autonomous transporting flying vector, preferably composed of a quadricopter, which takes care of transporting in flight such profile up to a height in which there is enough wind to support in flight and/or for the flight of the profile itself.

The above and other objects and advantages of the invention, as will appear from the following description, are obtained with a system for starting the flight of power wing airfoils as claimed in claim 1.

Moreover, the above and other objects and advantages of the invention are obtained with a process for starting the flight of power wing airfoils as claimed in claim 7.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention, as appears from the enclosed claims.

The present invention will be better described by some preferred embodiments thereof, provided as a non-limiting example, with reference to the enclosed drawings, in which:

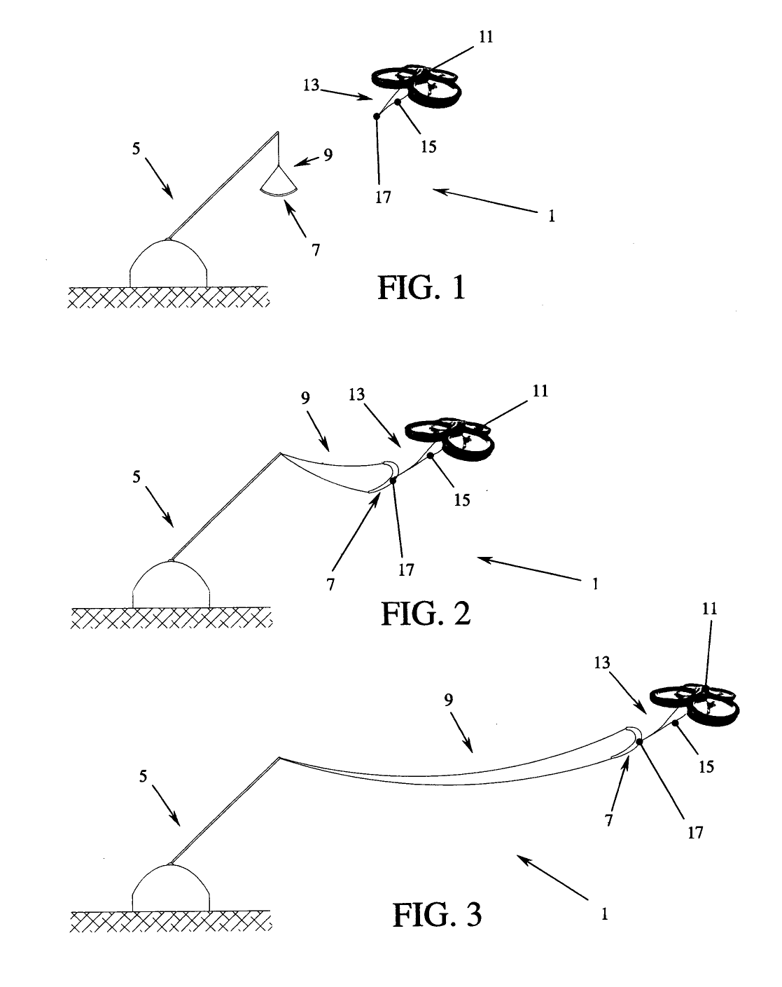

FIGS. 1, 2 and 3 show some steps of the process of starting the flight according to the present invention through a system according to the present invention; and

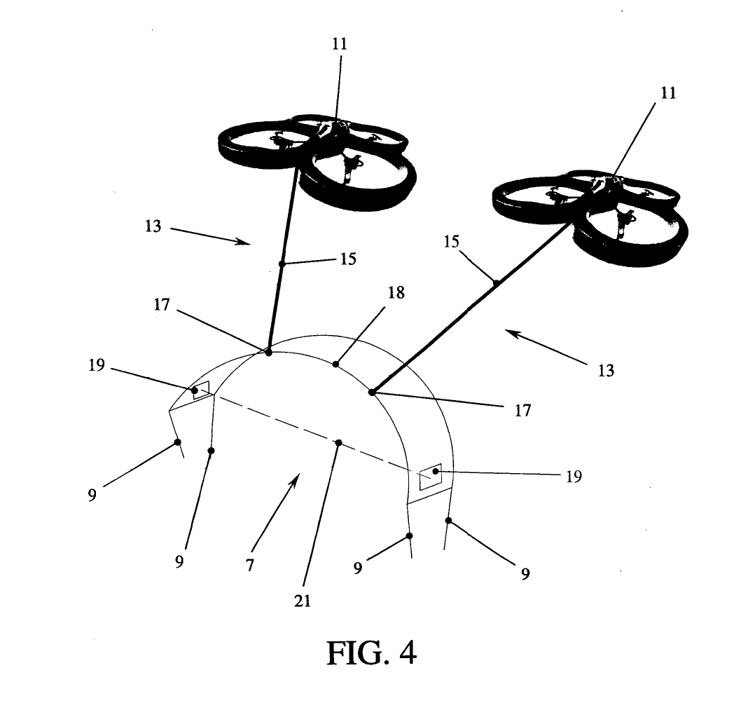

FIG. 4 shows an alternative embodiment of the system for starting the flight according to the present invention.

With reference to the Figures, it is possible to note that the system 1 for starting the flight of power wing airfoils 7, in particular for a wind generator 5, comprises:

at least one wing profile 7 operatively connected, through respective control tie-rods 9 as known in the art, to suitable winches or other control mechanisms (not shown) of the flight of the related wing profile 7;

at least one autonomous transporting flying vector 11 adapted to be connected through disengageable connecting means 13 to at least one wing profile 7 and to transport in flight such wing profile 7.

Preferably, such disengageable connecting means 13 are composed of at least one dragging cable 15 having a first end connected to such autonomous transporting flying vector 11 and a second opposite end to such first end equipped with at least one actuatable engaging/disengaging device 17 adapted to be engaged/disengaged to and from a respective engagement point arranged on the wing profile 7 and, for example, arranged along the attachment edge of the wing profile 7 itself. In a preferred alternative, as it is possible to note in particular in FIG. 4, it is possible to provide that the engagement point of the actuatable engaging/disengaging device 17 is arranged along the outlet edge 18 of the wing profile 7 in order to enable the starting of flight of the wing profile 7, so that this latter one, once having reached the desired flight height and having been disengaged from the autonomous transporting flying vector 11, can take the falling speed along the correct direction, exploiting the force of gravity and easily exit from a possible stalling situation.

Preferably, such actuatable engaging/disengaging device 17 is at least one electromagnetic hook and such engagement point arranged on the wing profile 7 is a related element made of metallic material, adapted to be magnetically connected to such electromagnetic hook. Obviously, the length, for example included between 4 m and 6 m, of the dragging cable 15 is the most suitable one to ensure the freedom of manoeuvre in flight of the autonomous transporting flying vector 11 without the flow produced by its own propellers necessarily impacts onto the wing profile 7.

As it is possible to note in particular always in FIG. 4, it is also possible to provide that, in case of wing profiles 7 whose sizes and weights are relatively high, the starting of flight of the wing profile 7 can be assisted by the combined action of two or more of such autonomous transporting flying vectors 11: in such case, in order to keep the geometry of the wing profile 7 unchanged, which could be subjected to distortions due to the combined traction exerted on different points of its own attachment or outlet edge 18 by two or more autonomous transporting flying vectors 11, such wing profile 7 of the system 1 according to the present invention can further comprise at least one measuring system 19, for example of the ultrasound type 21, which high frequency triangulates the relative positions of the autonomous transporting flying vectors 11 and of the wing profile 7.

In a preferred embodiment of the system 1 according to the present invention, such autonomous transporting flying vector 11 is a helicopter with one or more propellers, such as, for example, a quadricopter, an octocopter, a multicopter, etc., and, still more preferably, with electric supply. In fact, the electric supply of the autonomous transporting flying vector 11 is particularly suitable, since the manoeuvre for starting the flight of the wing profile 7 can be completed in few minutes and, therefore, compatibly with the energetic autonomy of such vector 11, possibly allowing the vector 11 itself to autonomously go back to a suitable recharging station, once having taken in flight and disengaged the wing profile 7 itself. For such purpose, the system 1 according to the present invention can therefore further comprise at least one landing, storing and energy recharging station (not shown) of at least one of such autonomous transporting flying vectors 11.

The present invention further refers to a process for starting the flight of power wing airfoils 7, in particular for wind generator 5, preferably through a system 1 according to the present invention as previously described, such system 1 in particular comprising at least one wing profile 7 operatively connected, through respective control tie-rods 9 as known in the art, to suitable winches or other control mechanisms (not shown) of the flight of the related wing profile 7, and at least one autonomous transporting flying vector 11 adapted to be connected through disengageable connecting means 13 to at least one wing profile 7 and a transport in flight such wing profile 7. In particular, the process according to the present invention comprises the steps of:

starting from a stalling position of the power wing profile 7 (like the one, for example, shown in FIG. 1), taking at least one autonomous transporting flying vector 11 next to such power wing profile 7;

engaging such power wing profile 7 to such autonomous transporting flying vector 11 through such disengageable connecting means 13 (as shown, for example, in FIG. 2);

transporting in flight such power wing profile 7 through traction by such autonomous transporting flying vector 11, possibly taking care of suitably unwinding the related control tie-rods 9 (as shown, for example, in FIG. 3);

once having reached, by such power wing profile 7, a height in which there is enough wind for supporting in flight and/or the flight of the profile 7, disengaging such autonomous transporting flying vector 11 from such power wing profile 7.

Possibly, the process according to the present invention can comprise the step of taking back such autonomous transporting flying vector 11 to a landing, storing and energy recharging station.

It is wholly clear that the present invention further refers to at least one computer program comprising program code means which, when run on a computer, autonomously and automatically perform all or part of the steps of the above mentioned process.

1.-9. (canceled)

10. A system for starting the flight of power wing airfoils, in particular for a wind generator, comprising:
a) at least one wing profile, operatively connected through control tie-rods, to control mechanisms for flight of the at least one wing profile; and
b) at least one autonomous transporting flying vector adapted to be connected through a disengageable connecting means to the at least one wing profile and adapted to transport the at least one wing profile in flight.

11. The system of claim 1, wherein the disengageable connecting means comprises:
a) at least one dragging cable having a first end connected to the autonomous transporting flying vector; and
b) a second opposite end connected to the first end equipped with at least one actuatable engaging/disengaging device adapted to be engaged/disengaged to and from a respective engagement point arranged on the at least one wing profile.

12. The system of claim 11, wherein the actuatable engaging/disengaging device comprises at least one electromagnetic hook and the engagement point arranged on the at least one wing profile is a related element made of metallic material adapted to be magnetically connected to the electromagnetic hook.

13. The system of claim 12, wherein the at least one wing profile further comprises at least one measuring system to triangulate relative positions of the autonomous transporting flying vector and the at least one wing profile.

14. The system of claim 13, wherein the at least one measuring system is preferably an ultrasound type measuring system adapted to high frequency triangulation.

15. The system of claim 10, wherein the engagement point of the actuatable engaging/disengaging device is arranged along an outlet, namely a leading edge of the wing profile.

16. The system of claim 10, wherein starting the flight of the wing profile is assisted by a combined action of two or more of the autonomous transporting flying carriers.

17. The system of claim 10, wherein the autonomous transporting flying carrier is a helicopter with one or more propellers, and preferably a quadricopter, an octocopter or a multicopter.

18. The system of claim 10, wherein the autonomous transporting flying carrier is with electric supply.

19. The system of claim 10, comprising at least one landing, storing and energy recharging station of at least one of the autonomous transporting flying carriers.

20. A process for starting the flight of power wing airfoils, in particular for wind generator, through the system of claim 10, comprising the steps of:
a) starting from a stalling position of the power wing profile, taking at least one autonomous transporting flying carrier next to the power wing profile;
b) engaging the power wing profile to the autonomous transporting flying carrier through the disengageable connecting means;
c) transport in flight the power wing profile through a traction by the autonomous transporting flying carrier, possibly taking care to perform a suitable unwinding of the control tie-rods; and
d) once having reached by the power wing profile a height in which there is enough wind for supporting in flight and/or a flight of the profile, disengage the autonomous transporting flying carrier from the power wing profile.

21. The process of claim 20, comprising the step of taking back the autonomous transporting flying carrier to a landing, storing and energy recharging station.

22. A computer program comprising program code means which, when run on a computer, perform the steps of the process according to claim 21.

23. A computer program comprising program code means which, when run on a computer, perform the steps of the process according to claim 22.
